(19) United States
(12) Patent Application Publication
(10) Pub. No.: US 2009/0235013 A1
(43) Pub. Date: Sep. 17, 2009

(54) Mass Storage Device Having Both Xip Function and Storage Function

(76) Inventor: Un Sik Seo, Seongnam (KR)

Correspondence Address: Thomas M. Galgano, 20 W. Park Avenue, Suite 204, Long Beach, NY, 11561, US

(21) Appl. No.: 12/083,328

(22) PCT Filed: Aug. 17, 2006
(86) PCT No.: PCT/KR2006/003226

§ 371 Date: Apr. 8, 2008

(30) Foreign Application Priority Data
Oct. 27, 2005 (KR) 10-2005-0101570
Mar. 22, 2006 (KR) 10-2006-0025969

(51) Int. Cl. G06F 12/02

(52) U.S. Cl. 711/103; 711/E12.008

(57) ABSTRACT

A mass storage device for mobile phone having both XIP function and storage function is disclosed. The mass storage device having both XIP function and storage function comprises a NAND flash memory divided into an XIP (execute-in-place) area for storing a program code and a storage area for storing a mass data; and a controller for controlling the XIP area in such a manner that a host can be accessible to the XIP area through a NOR interface port at the request of an arbitrary access from the host and performing a storage interface function in such a manner that the host can be accessible to the storage area in a block unit through a storage interface port at the access request of a block unit from the host.

### TECHNICAL FIELD

The present invention relates to a mass storage device for mobile phone having both XIP function and storage function, and more particularly to a mass storage device for mobile phone having both XIP function and storage function, in that a NAND flash memory is divided into an XIP (execute-in-place) area for executing a program code and a storage area for storing a mass data and a controller for directly arbitrating and controlling the XIP function and the storage control function is implemented, whereby each function of the NOR flash memory and the NAND flash memory can be implemented in one NAND flash memory.

### BACKGROUND ART

Generally, a flash memory is a kind of a nonvolatile memory such as a ROM (read only memory) in that a recorded content once is stored without the supply of the power and a writing function is provided. The flash memory is divided into a NOR flash memory having cells arranged in parallel between bit line and ground line and a NAND flash memory having cells arranged in series.

The NOR flash memory using a random access manner capable of reading and writing an arbitrary address irrelevantly to the order of the cells can be accessible in a bite unit. However, since the contacted electrodes are needed per each cell, there is a defect in that the cell area is very large in comparison with the NAND flash memory.

In the NAND flash memory, the corresponding block is selected and then, each cell connected to each other in series is read. Accordingly, the NAND flash memory can be accessible in a block unit.

Here, in the NAND flash memory, the block means a unit capable of deleting with a deleting operation once and the page means a data size capable of reading or writing during a reading/writing operation.

The NAND flash memory has merits in comparison with the NOR flash memory in that the writing speed is fast, the cost is low and the capacity is large, thereby it can be widely used as a mass storage device. However, it is impossible to be accessible in a bite unit and cannot provide a XIP function (execute-in-place) capable of directly executing the recorded data without moving it to a main memory.

Accordingly, the NAND flash memory is used as an auxiliary data storage device and a boot code for system booting is stored in the NOR flash memory having the XIP function.

FIG. 1 is a block diagram illustrating a conventional mass storage device for mobile phone.

As shown in FIG. 1, the NAND flash memory 200 is used as the auxiliary data storage device and the boot code for system booting in a CPU 100 and a software for controlling the NAND flash memory as the storage device are stored in the NOR flash memory, as described above.

A DRAM 400 is a main memory used in the operation of the program and the system. Here, the program for controlling the NAND flash is moved to the DRAM 400 to be executed.

However, in the conventional mass storage device, there is a defect in that a separated NOR flash memory of high cost and low capacity is required so as to store the program.

In order to solve the problem, Korean patent application No. 10-2001-54988 is disclosed in that a program code such as a boot code and so on is stored in the NAND flash memory and the corresponding program code is copied into a main memory during the execution of the program then, it reads out in a bite unit, thereby executing the program.

However, in the above techniques, since the boot code should be moved to the main memory in order to execute the boot code during the booting of the system, there is a problem in that the execution time is delayed. Also, the available storing space of the main memory is decreased on account of the boot code moved to the main memory.

In order to solve this problem, Korean patent No. 10-493884 is disclosed in that a serial flash controller device having a predetermined storage capacity is accessible to a serial flash memory to read the entire page pertaining to the necessary data, so that the requested data is transmitted to the main controller or is executed to support the XIP function in the serial flash memory.

In the Korean patent, since the NAND flash memory can be used as the NOR flash memory, there has a big merit in terms of the cost reduction and the execution speed improvement. However, there is a problem as ever that the memory for storing the program code and the storage memory for storing the mass data should be manufactured separately.

Accordingly, the mass storage device capable of storing the program code and the mass data in one memory has been highly demanded.

### DISCLOSURE

### Technical Problem

Accordingly, the present invention has been made to solve the above-mentioned problems occurring in the prior art, and an object of the present invention is to provide a mass storage device for mobile phone having both XIP function and storage function in that a NAND flash memory is divided into an XIP (execute-in-place) area for executing a program code and a storage area for storing a mass data and a controller for directly arbitrating and controlling the XIP function and the storage control function is implemented, so that two functions of the NOR flash memory and the NAND flash memory can be implemented in one NAND flash memory.

### Technical Solution

To accomplish the object, the present invention provides a mass storage device having both XIP function and storage function comprising: a NAND flash memory divided into an XIP (execute-in-place) area for storing a program code and a storage area for storing a mass data; and a controller for controlling the XIP area in such a manner that a host can be accessible to the XIP area through a NOR interface port at the request of an arbitrary access from the host and performing a storage interface function in such a manner that the host can be accessible to the storage area in a block unit through a storage interface port at the access request of a block unit from the host.

Preferably, the controller comprises: a XIP memory controller connected to the host through a NOR interface for controlling the XIP area in such a manner that the host can be accessible to the XIP area at the arbitrary access request of the host; a cache memory for temporarily storing data received from the host and the XIP area; a storage controller connected to the host through a storage interface for performing the storage interface function in such a manner that the host can be accessible to the storage area in the block unit at the access request of the block unit from the host; a disk buffer for temporarily storing data received from the host and the storage area; a system controller for selectively driving the XIP memory controller and the storage controller according to a data access manner requested from the host and controlling entire circuit operations; and a NAND controller interposed between the system controller and the NAND flash memory for controlling the NAND flash memory according to a NAND interface manner.

Preferably, the XIP memory controller comprises a NOR host drive for supporting any operation at the request of the NOR flash interface and generating and renewing a memory manager table for the XIP and a XIP manager for converting an access address requested from the host into a physical address and performing a memory manager operation on a bad block; the storage controller comprises a storage host drive for managing a protocol related to the storage and converting an information related to the storage into any data form suitable for the NAND flash and a storage manager for converting an access address requested from the host into a LUN (logical unit number) and performing a memory manager operation on the bad block; and the system controller serves to convert the physical address received from the XIP memory controller and the LUN (logical unit number) received from the storage controller into a block page address to be transmitted to the NAND controller.

Preferably, the NAND controller comprises a flash translation layer for converting the requested physical address and logical unit number into an I/O command and a block address and managing and controlling a physical state of the NAND flash.

Preferably, in the NOR interface and the storage interface, a part line of the address port, a data line, an output driving line, and a writing driving line can be used in common.

Preferably, the NOR interface and the storage interface further comprise a waiting signal line for solving a difference between a data read time of the host and a data access time of a block unit in the NAND flash memory.

### Advantageous Effects

Accordingly, the NAND flash memory is divided into the XIP (execute-in-place) area for executing the program code and the storage area for storing the mass data and the controller for directly arbitrating and controlling the XIP function and the storage control function is implemented, thereby each function of the NOR flash memory and the NAND flash memory can be implemented in one NAND flash memory.

### DESCRIPTION OF DRAWINGS

The above as well as the other objects, features and advantages of the present invention will be more apparent from the following detailed description taken in conjunction with the accompanying drawings, in which:

FIG. 1 is a block diagram illustrating a conventional mass storage device for mobile phone;

FIG. 2A is a block diagram illustrating a mass storage device for mobile phone according to one embodiment of the present invention;

FIG. 2B is a block diagram illustrating a mass storage device for mobile phone according to another embodiment of the present invention;

FIG. 3 is a block diagram illustrating an interface structure of the present invention;

FIG. 4 is a conceptional view illustrating a structure of a mass storage device for mobile phone according to the present invention from a standpoint of a CPU;

FIG. 5 is a stratified view illustrating a schematic construction of the controller according to the present invention;

FIG. 6 is a block diagram illustrating a detailed structure of the controller of FIG. 5; and

FIG. 7 is a waveform diagram illustrating a signal of the controller according to the present invention.

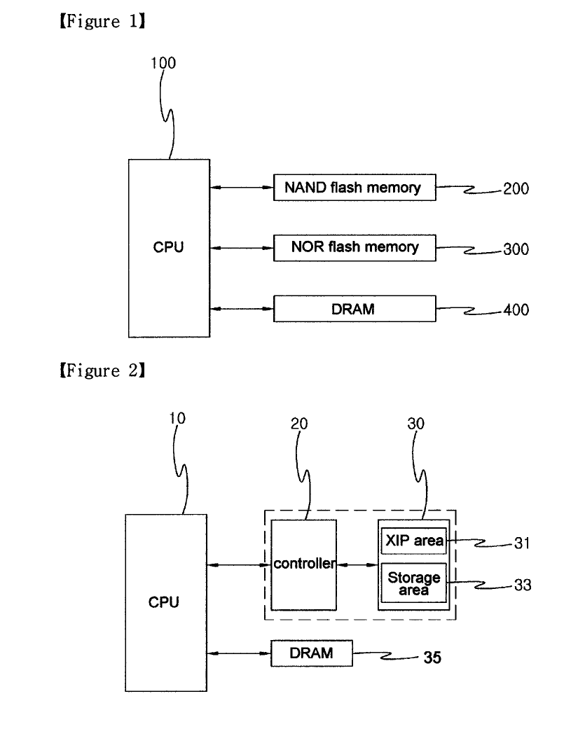

### BEST MODE

A preferred embodiment of the invention will be described in detail below with reference to the accompanying drawings.

FIG. 2A is a block diagram illustrating a mass storage device for mobile phone according to one embodiment of the present invention.

As shown in FIG. 2A, the mass storage device for mobile phone according to one embodiment of the present invention includes a CPU (central processing unit) 10, a NAND flash memory 30, a controller 20 interposed between the CPU 10 and the NAND flash memory 30, and a DRAM (dynamic random access memory) 35 as a main memory directly connected to the CPU 10.

The NAND flash memory 30 according to the present invention is divided into an XIP (execute-in-place) area 31 for storing a program code such as a boot code and so on and a storage area 33 for storing a mass data. Here, the partition ration of the XIP area 31 to the storage area 33 can be variable according to the environment or the purpose thereof.

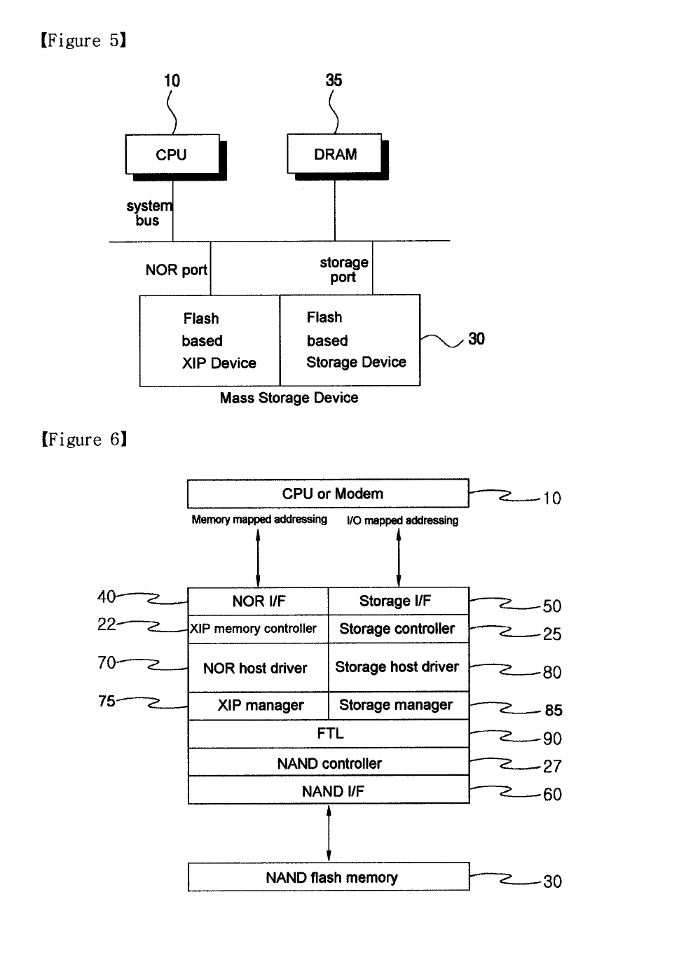

The controller 20 serves to control the XIP area 31 in such a manner that the CPU 10 can be accessible to the XIP area 31 at the request of an arbitrary access from the CPU 10. Also, the controller performs a storage interface function in such a manner that the CPU 10 can be accessible to the storage area 33 in the block unit at the access request of a block unit from the CPU 10. The detailed construction thereof will be described in the explanation of FIG. 5 and FIG. 6 below.

The controller 20 and the NAND flash memory 30 are mounted on one semiconductor package in the form of a multi-chip package. In the mass storage device, since a separate host drive for controlling the NAND flash memory 30 is not required, it can provide a convenience for use to a user.

FIG. 2B is a block diagram illustrating a mass storage device for mobile phone according to another embodiment of the present invention.

As shown in FIG. 2A, the NAND flash memory 30 and the DRAM 35 are connected to the CPU (host) 10 through the controller 20. In this construction of the mass storage device, the controller 20 and the NAND flash memory 30 are also mounted on one semiconductor package in the form of a multi-chip package. Moreover, because the separate host drive for controlling the NAND flash memory 30 is not required, it can provide a convenience for use to a user.

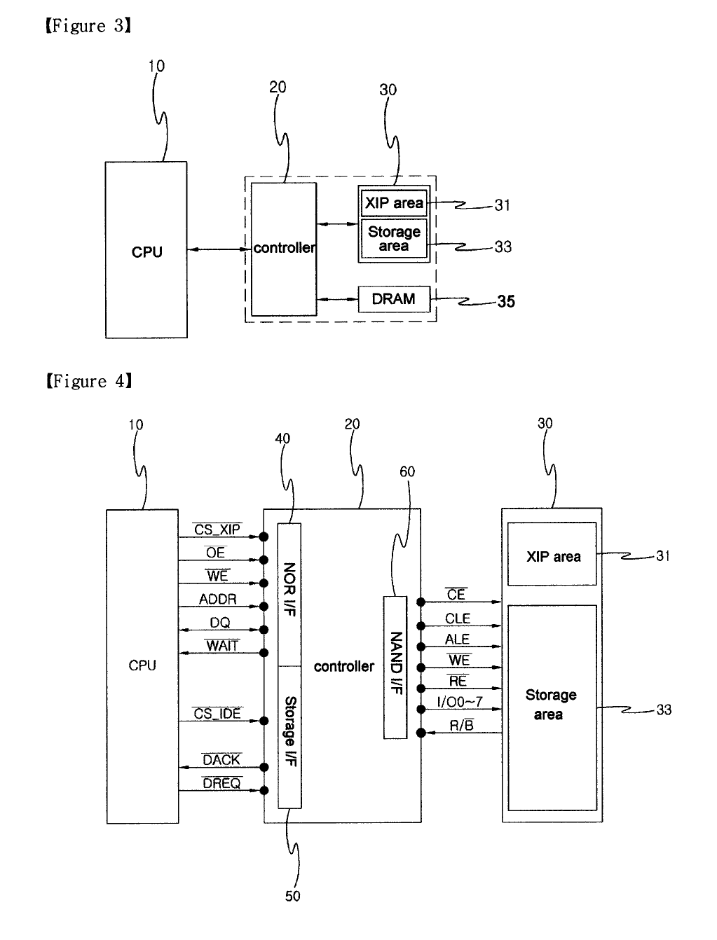

FIG. 3 is a block diagram illustrating an interface structure of the present invention.

As shown in FIG. 3, the controller 20 according to the present invention includes a NOR interface 40 for interfacing with the CPU 10, a storage interface 50, and a NAND interface 60 for interfacing with the NAND flash memory 30.

The NOR interface 40 includes a chip selection port (CS_XIP) for performing the XIP function as an interface accessible to a program code, an output controlling port (OE), a writing controlling port (WE) for recording a data in the NAND flash memory 30, an address port (ADDR) for inputting reading or recording address data, a data port (DQ) for inputting and outputting reading or recording data, and a waiting port (WAIT) for transmitting a wait signal to CPU 10 in order to solve the difference between a data reading time of the CPU 10 of a data access time of a block unit in the NAND flash memory 30.

The storage interface 50 includes a chip selection port (CS_IDE) for performing a storage interface controlling function through the CPU 10, a DMA request port (DREQ) for performing the DMA (direct memory access) function, and a DMA acknowledgement port (DACK) and so on.

In the storage interface 50, a mass storage interface of various configurations such as an IDE/ATA, a hard disk manner, a SD (secure digital) card interface, multimedia card (MMC) interface, a memory stick interface and so on can be applied.

In the embodiment of the present invention, the IDE/ATA protocol is adopted. IDE/ATA protocol comprises an IDE (intelligent drive electronics) used as a hardware interface standard and ATA (advanced technology attachment) used as a protocol standard.

In the storage interface 50, the output controlling port (OE), the writing controlling port (WE), a part line of the address port(ADDR), the data port (DQ) and the waiting port (WAIT) among the NOR interface ports can be used in common, so that the number of the connection ports can be decreased and the operation efficiency can be improved.

In case of the address port, the NOR interface 40 for providing the XIP function has twenty six address lines and the storage interface 50 using the IDE/ATA interface has only three lines (0 to 2) among the address lines for addressing tracks and sectors.

The NAND interface 60 includes a chip selection port (CE) as an NAND flash memory access interface, input/output ports (I/O 0-7) for inputting and outputting the address, data and command, a command latch driving port (CLE) for latching the command inputted through the input/output ports, an address latch driving port (ALE) for latching the address inputted through the input/output ports (I/O 0-7), a writing driving port (WE) for recording the data inputted through the input/output ports (I/O 0-7) in the NAND flash memory 30, a reading driving port (RE) for transmitting the data outputted through the input/output ports (I/O 0-7), and a ready and busy port (R/B) for displaying a preparatory states of the present NAND flash memory 30.

FIG. 4 is a conceptional view illustrating a structure of a mass storage device for mobile phone according to the present invention from a standpoint of a CPU.

As shown in FIG. 4, where the CPU 10 is approached to the mass storage device for mobile phone according to the present invention, since the CPU 10 is approached to the XIP area 31 and the storage area 33 through the NOR interface port and the storage interface port respectively, the CPU 10 recognizes the mass storage as two devices that is, one flash memory for XIP and one hard disk.

In other words, the CPU 10 recognizes that the XIP area 31 and the storage area 33 are physically and completely separated from each other. Accordingly, the present invention is characterized in that the different two flash memories (NOR flash memory and NAND flash memory) seems to be existed in the storage device using one NAND flash memory.

FIG. 5 is a stratified view illustrating a schematic construction of the controller according to the present invention and FIG. 6 is a block diagram illustrating a detailed structure of the controller of FIG. 5.

As shown, the controller 20 according to the present invention includes an internal clock generating portion 21, a XIP memory controller 22, a cache memory 23, a system controller 24, a storage controller 25, a disk buffer 26, a NAND controller 27, and a flash manager 28.

The XIP memory controller 22, which is connected to the CPU 10 through the NOR interface 40, serves to control the XIP area 31 in such a manner that the CPU 10 can be accessible to the XIP area 31 at the arbitrary access request of the CPU 10.

The XIP memory controller 22 is driven by a chip selection signal (nCS_XIP). Also, the XIP memory controller 22 serves to convert the address data inputted through the address port (ADDR) into a physical address and transmit it to the system controller 24. As shown in FIG. 5, in the XIP memory controller 22, a XIP host drive 70 and a XIP manager 75 for controlling the execution in place is installed through a software program or hard-wired to the chip. The XIP host drive 70 serves to support any operation (read, write, deletion and so on) at the request of the NOR flash interface. Also, the XIP (NOR) host drive 70 is any program for generating and controlling a memory manager table for the XIP. The XIP manager 75 serves to convert the request address into a physical address, control the operation of the XIP memory controller 22 in a generation of a bad block, and perform the controlling and managing operations according to the kind of the NAND flash. Moreover, the XIP manager 75 serves to perform the determinating function of the priority order through the information exchange with the storage manager 85.

In the XIP memory controller 22, the data of the block unit read from the XIP area 31 of the NAND flash memory 30 is transferred to the cache memory 23 and only execution program code read from the cache memory 23 is transmitted to the DRAM 35 as the main memory. Also, in the XIP memory controller 22, the data read from the XIP area 31 of the NAND flash memory 30 and stored in the cache memory 23 and the storage information thereof are recorded in the specific place and the data stored in the cache memory 23 is transmitted to the DRAM 35 at the request of the same data, thereby shortening the data access time.

The storage controller 25, which is connected to the CPU 10 through the storage interface 50, performs the storage interface function in such a manner that the CPU 10 can be accessible to the storage area 33 in the block unit at the access request of the block unit from the CPU. The storage controller 25 is driven by a chip selection signal (nCS_IDE). Also, the storage controller 25 serves to convert the address data inputted through the three lines among the address lines into a LUN (logical unit number) and transmit it to the system controller 24.

As shown in FIG. 5, in the storage controller 25, a storage host drive 80 and a storage manager 85 for the storage interface is installed through a software program or hard-wired to the chip. The storage host drive 80 is any program for supporting and interpreting a protocol related to the storage and converting the information related to the interrupt manager and the storage into any data form suitable for the NAND flash. The storage manager 85 serves to convert the request address into the LUN (logical unit number) and perform the manager operation on the bad block, the data protection for the urgent interruption of electric power, and the controlling and managing operations according to the kind of the NAND flash and so forth. Moreover, the storage manager 85 serves to perform the determinating function of the priority order through the information exchange with the XIP manager 75.

In the storage controller 25, the data of block unit read from the storage area 33 of the NAND flash memory 30 is temporarily stored in the disk buffer 26 and then, transmitted to the CPU 10.

The system controller 24 serves to selectively drive the XIP memory controller 22 and the storage controller 25 according to the data access manner requested from the CPU 10 and control the entire circuit operations. Also, the system controller 24 serves to convert the physical address received from the XIP memory controller and the LUN (logical unit number) received from the storage controller 25 into a block page address capable of treating in the NAND controller 27 to be transmitted to the NAND controller 27, thereby the NAND flash memory 33 can be used in two interfaces that is, the NOR interface and the storage interface at the same time.

In the meantime, the system controller 24 serves to transmit a control signal to a demultiplexer, which the data lines of the cache memory 23 and the buffer 26 is inputted to, to selectively output the necessary data. For example, where the control signal of the system controller 24 is “0”, the data of the cache memory 23 is selectively outputted. Also, in case that the control signal of the system controller 24 is “1”, the data of the disk buffer 26 is selectively outputted.

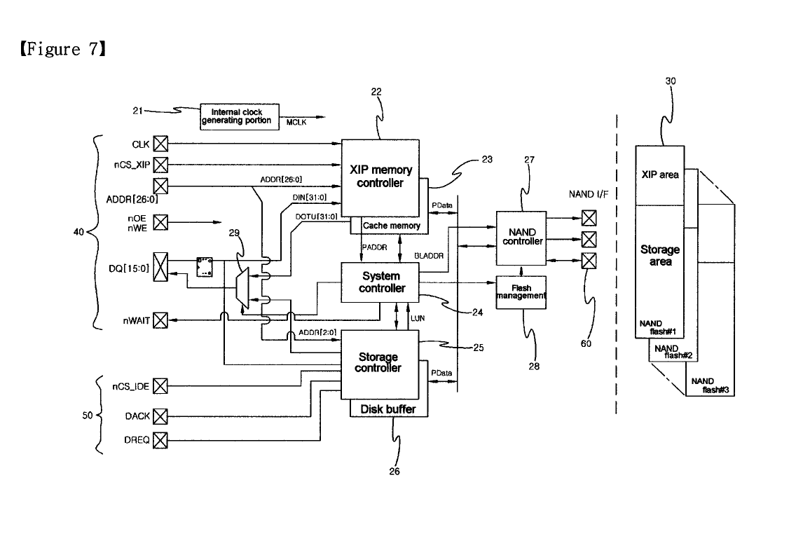

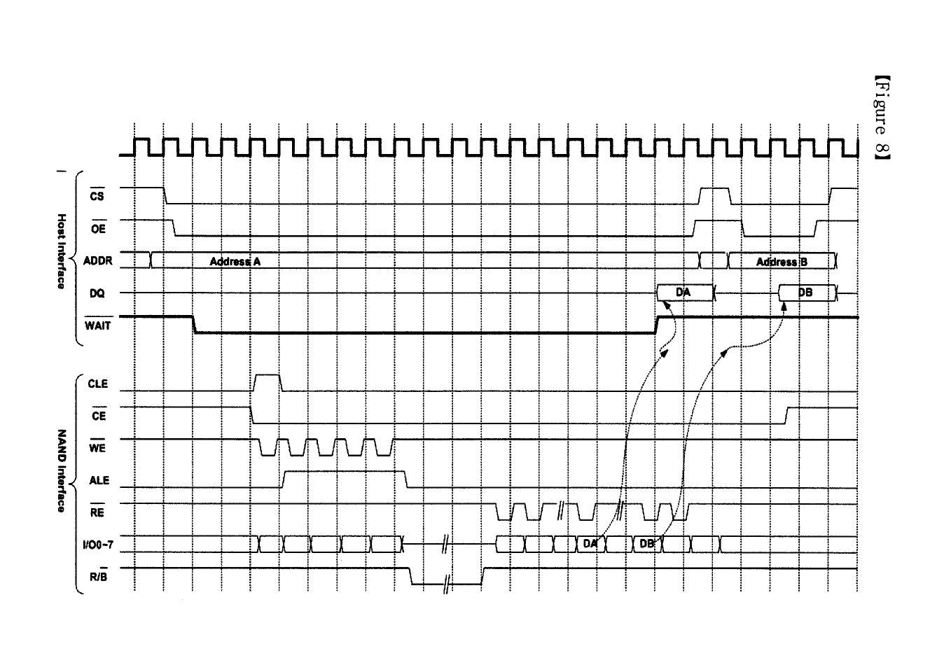

Also, the system controller 24 can control the timing by outputting the wait signal (nWAIT). It will be described in the explanation of FIG. 7.

The NAND controller 27 interposed between the system controller 24 and the NAND flash memory 30 serves to control the NAND flash memory 30 according to the NAND interface method. That is, The NAND controller 27 serves to read and record the data from the NAND flash memory 30 on the basis of the block page address received from the system controller 24.

As shown in FIG. 5, in the NAND controller 27, a FTL (flash translation layer) 90 for managing and controlling the NAND flash memory 30 is installed through a software program or hard-wired.

The flash translation layer 90 serves to convert the requested physical address and logical unit number into an I/O command and a block address and maintain and manage the information on the bad block. Also, the flash translation layer 90 serves to assign the operation thereof during the reading, programming and deleting of the NAND flash and store and control the physical state of the NAND flash, thereby protecting the user's data from the bad block.

FIG. 7 is a waveform diagram illustrating a signal of the controller according to the present invention.

In the general NAND flash memory 30, the data reading of block unit is performed. Meanwhile, since the code unit of the CPU 10 is very small, the time difference between them is generated. In order to solve this time difference, the wait signal is provided (note a Wait of FIG. 7). Accordingly, where the code reading is performed without the wait time during the command code execution of the CPU 10, the code execution waiting of the CPU 10 is induced by the waiting signal generated from the storage device. Here, when the memory bank of the CPU 10 for performing the code cannot receive the waiting signal, it can be used as an exceptional processing signal in the CPU 10.

As can be seen from the foregoing, in the mass storage device for mobile phone having both XIP function and storage function, a NAND flash memory is divided into the XIP (execute-in-place) area for executing the program code and the storage area for storing the mass data and the controller for directly arbitrating and controlling the XIP function and the storage control function is implemented, thereby each function of the NOR flash memory and the NAND flash memory can be implemented in one NAND flash memory.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

the NAND flash memory is divided into the XIP (execute-in-place) area for executing the program code and the storage area for storing the mass data and the controller for directly arbitrating and controlling the XIP function and the storage control function is implemented, thereby each function of the NOR flash memory and the NAND flash memory can be implemented in one NAND flash memory.

1. A mass storage device having both XIP function and storage function comprising:
a NAND flash memory divided into an XIP (execute-in-place) area for storing a program code and a storage area for storing a mass data; and
a controller for controlling the XIP area in such a manner that a host can be accessible to the XIP area through a NOR interface port at the request of an arbitrary access from the host and performing a storage interface function in such a manner that the host can be accessible to the storage area in a block unit through a storage interface port at the access request of a block unit from the host.

2. A mass storage device having both XIP function and storage function as claimed in claim 1 wherein the controller comprises:
a XIP memory controller connected to the host through a NOR interface for controlling the XIP area in such a manner that the host can be accessible to the XIP area at the arbitrary access request of the host;
a cache memory for temporarily storing data received from the host and the XIP area;
a storage controller connected to the host through a storage interface for performing the storage interface function in such a manner that the host can be accessible to the storage area in the block unit at the access request of the block unit from the host;
a disk buffer for temporarily storing data received from the host and the storage area;
a system controller for selectively driving the XIP memory controller and the storage controller according to a data access manner requested from the host and controlling entire circuit operations; and
a NAND controller interposed between the system controller and the NAND flash memory for controlling the NAND flash memory according to a NAND interface manner.

3. A mass storage device having both XIP function and storage function as claimed in claim 2 wherein the XIP memory controller comprises a NOR host drive for supporting any operation at the request of the NOR flash interface and generating and renewing a memory manager table for the XIP and a XIP manager for converting an access address requested from the host into a physical address and performing a memory manager operation on a bad block; the storage controller comprises a storage host drive for managing a protocol related to the storage and converting an information related to the storage into any data form suitable for the NAND flash and a storage manager for converting an access address requested from the host into a LUN (logical unit number) and performing a memory manager operation on the bad block; and the system controller serves to convert the physical address received from the XIP memory controller and the LUN (logical unit number) received from the storage controller into a block page address to be transmitted to the NAND controller.

4. A mass storage device having both XIP function and storage function as claimed in claim 2 wherein the NAND controller comprises a flash translation layer for converting the requested physical address and logical unit number into an I/O command and a block address and managing and controlling a physical state of the NAND flash.

5. A mass storage device having both XIP function and storage function as claimed in claim 2 wherein in the NOR interface and the storage interface, a part line of the address port, a data line, an output driving line, and a writing driving line can be used in common.

6. A mass storage device having both XIP function and storage function as claimed in claim 2 wherein the NOR interface and the storage interface further comprise a waiting signal line for solving a difference between a data read time of the host and a data access time of a block unit in the NAND flash memory.
